(19) United States
(12) Patent Application Publication
(10) Pub. No.: US 2008/0048031 A1
(43) Pub. Date: Feb. 28, 2008

(54) METHOD AND APPARATUS FOR GENERATING AN INVENTORY AT A LOCATION IN RESPONSE TO AN EVENT

(76) Inventors: Nancy Jean Milliner, Round Rock, TX (US); JOSE R. SANTOS, Austin, TX (US)

Correspondence Address: IBM CORP (YA);C/O YEE & ASSOCIATES PC, P.O. BOX 802333, DALLAS, TX, 75380, US

(21) Appl. No.: 11/466,785

(22) Filed: Aug. 24, 2006

(51) Int. Cl. G06Q 30/00

(52) U.S. Cl. 235/385

(57) ABSTRACT

A computer implemented method, apparatus, and computer usable program code for handling security events. Data is gathered from a plurality of radio frequency identifier tags present at the location through a set of radio frequency identifier tag readers located at the location to form tag data in response to detecting the occurrence of a security event at a location. The tag sends data to a remote location for processing.

### BACKGROUND OF THE INVENTION

1. Field of the Invention

The present invention relates generally to an improved data processing system and in particular to a method and apparatus for generating an inventory. Still more particularly, the present invention relates to a computer implemented method, apparatus, and computer usable program code for generating an inventory in response to an event occurring at a location.

2. Description of the Related Art

Customers of insurance companies purchase insurance for many different purposes. For example, insurance may be purchased for auto, home, health, and businesses. With respect to businesses, insurance may be purchased to cover various aspects of the business. For example, business owners may purchase insurance to protect buildings and items located in buildings. Insurance may be purchased to cover against losses cause by fire or theft. Home owners also may purchase insurance to protect against similar types of losses.

When an event, such as a fire occurs, oftentimes, it is impossible to obtain a verifiable and detailed inventory of the items located in a building. A customer may provide a list or electronic file containing the inventory that the customer claims was present prior to an event, such as fire or theft. However, verification of what items were actually present is often hard to obtain. As a result, determining whether a claim is fraudulent is often hard to identify. Consequently, insurance companies pay out countless dollars in fraudulent claims filed by their customers for replacement items that the customers did not own. Insurance companies recognize this risk for these types of insurance policies, and as a result, premiums increase for other customer due to the risk of fraud. In addition to increasing premiums for customers, fraudulent payouts cost insurance carriers money and increase losses.

Solutions include photographs and documents identifying possessions. These types of proof, however, do not verify whether the items were actually present in a location at the time of the event. Other types of proof include calling upon a witness to verify certain possessions were in the location at the time of the event.

### SUMMARY OF THE INVENTION

The present invention provides a computer implemented method, apparatus, and computer usable program code for handling security events. Data is gathered from a plurality of radio frequency identifier tags present at a location through a set of radio frequency identifier tag readers located at the location to form tag data in response to detecting the occurrence of a security event at the location. The tag data is sent to a remote location for processing.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a diagram illustrating components used for handling security events in accordance with an illustrative embodiment;

FIG. 4 is a diagram illustrating components used to detect security events and collect information on items in accordance with an illustrative embodiment;

FIG. 5 is a flowchart of a process for generating an inventory in response to an event occurring at a location in accordance with an illustrative embodiment; and

FIG. 6 is a flowchart of a process for receiving and processing data collected during a security event in accordance with an illustrative embodiment.

### DETAILED DESCRIPTION OF THE PREFERRED EMBODIMENT

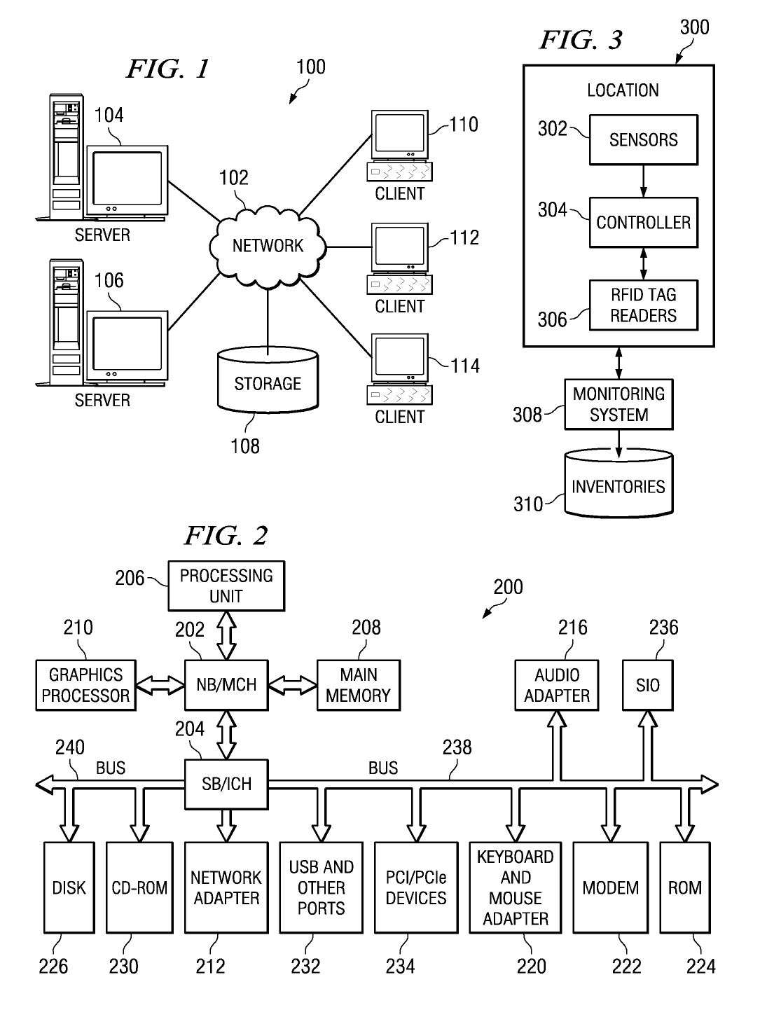

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. These clients are controllers for security systems in these illustrative examples. Each client is located in a location, such as a store, home, or warehouse containing items. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer or controller, such as server 104 or client 110 in FIG. 1, in which computer usable code or instructions implementing the processes may be located for the illustrative embodiments. When implemented as a client, data processing system 200 functions as a controller for a security system in these illustrative examples.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations

The illustrative embodiments provide for a computer implemented method, apparatus, and computer usable program code for compiling source code. The methods of the illustrative embodiments may be performed in a data processing system, such as data processing system 100 shown in FIG. 1 or data processing system 200 shown in FIG. 2.

The illustrative embodiments provide a computer implemented method, apparatus, and computer usable program code for handling security events. A security event is any event detected through a security system. In these examples, a security event may be, for example, detection of a fire, smoke, glass breakage, motion within a monitored area, opening of a monitored door or window, or some other event monitored by the system.

Turning now to FIG. 3, a diagram illustrating components used for handling security events is depicted in accordance with an illustrative embodiment. In this example, location 300 is a monitored location. Location 300 contains sensors 302, which are connected to controller 304. Additionally, location 300 in these examples, contain radio frequency identifier (RFID) tag readers 306, which also are connected to controller 304.

Sensor 302, in these examples, may take various forms. For example, these sensors may be a set of one or more sensors that may be of the same or different type. Sensor 302 may include, for example, a fire detector, smoke detector, motion detector, glass breakage detector, or a door sensor. Of course, sensor 302 may include other types of sensors not described herein. The types of sensors specified in the illustrative embodiments are meant only for purposes of illustration and not meant to limit types of sensors that may be used for sensor 302.

RFID tag readers 306 are a set of RFID tag readers and may be implemented using any currently available RFID tag readers. This set may include one or more RFID tag readers. RFID tag readers 306 also are referred to as interrogators and typically each one contains an antenna package with a transceiver and decoder. A RFID tag reader emits a signal to activate an RFID tag so that the RFID tag reader can read and possibly even write data to the RFID tag.

Controller 304, in these examples, may be implemented using any device that may monitor and/or control sensor 302 as well as RFID tag readers 306. In these illustrative examples, controller 304 is implemented using data processing system 200 in FIG. 2. Depending on the particular implementation, an application specific integrated chip may be used to implement controller 304.

When a security event is detected by sensor 302, controller 304 activates RFID tag readers 306 to collect data from any items associated with RFID tags within location 300. The RFID tags transmit the tag data identifying the items at location 300 to RFID tag readers 306 once RFID tag readers 306 initializes the RFID tags. The incoming radio frequencies from RFID tag readers 306 are gathered by an RFID antenna which generates a minute electrical current. This electrical current then powers an integrated circuit within the RFID tag to send a response back to the reader. A RFID tag may be associated with an item in a number of ways. For example, the RFID tag may be attached or glued to the item. The RFID tag may be affixed to the item on a label or on packaging used to contain the item. The RFID tag also could be integrated as part of the item.

An identification of the security event as well as data collected through RFID tag readers 306 is sent to monitoring system 308 by controller 304. Controller 304 also may generate a local back up copy of the data that is stored within controller 304, in these examples. With this feature, the local back up copy is stored using a storage device, such as a hard disk drive or optical disk drive. Monitoring system 308, in these examples, is a remote data processing system such as data processing system 200 in FIG. 2, located in another location other than location 300. For example, monitoring system 308 may be located at a security company, or a location designated by a customer. Monitoring system 308 takes the data received from controller 304 and generates an inventory of items present in location 300 when the security event was detected. This inventory is stored in inventories 310 in this example. Inventories 310 is a database or collection of inventories generated from data received from security systems at different locations. In this manner, the illustrative embodiments allow for an accurate identification of items present in location 300 when a security event occurs.

This type of identification is especially useful to insurance companies. For example, if a fire occurs at location 300, and all of the items in location 300 are destroyed, an accurate inventory of the items present at the time the security event was detected is stored in inventories 310.

In this example, the detection of smoke or fire at location 300 triggers the collection of data on the items present in location 300. As a result, the inventory generated by monitoring system 308 is accurate with respect to items present prior to the destruction of those items by the fire. This feature also is useful in the event that an intrusion is detected by a motion sensor or door sensor and items are stolen from the location.

In these examples, controller 304 sends data collected from RFID tag readers 306 to monitoring system 308 though an internet connection, such as DSL, or cable. Of course, a phone line may also be used to transmit the data to monitoring system 308 depending on the particular implementation. In the instance that monitoring system 308 is an insurance carrier, monitoring system 308 also determines whether the security event is a valid security event. For example, a false alarm may have occurred in which an employee accidentally triggered a motion sensor or a smoke sensor. In this case, no action is taken using the data received from controller 304. If, however, an actual intrusion or fire had occurred in these examples, monitoring system 308 processes the data to generate the inventory for location 300 and begin a claim process.

When controller 304 detects a security event, an alarm or call is generated to the authorities. These authorities may be, for example, a police department, a fire department, and/or a security company.

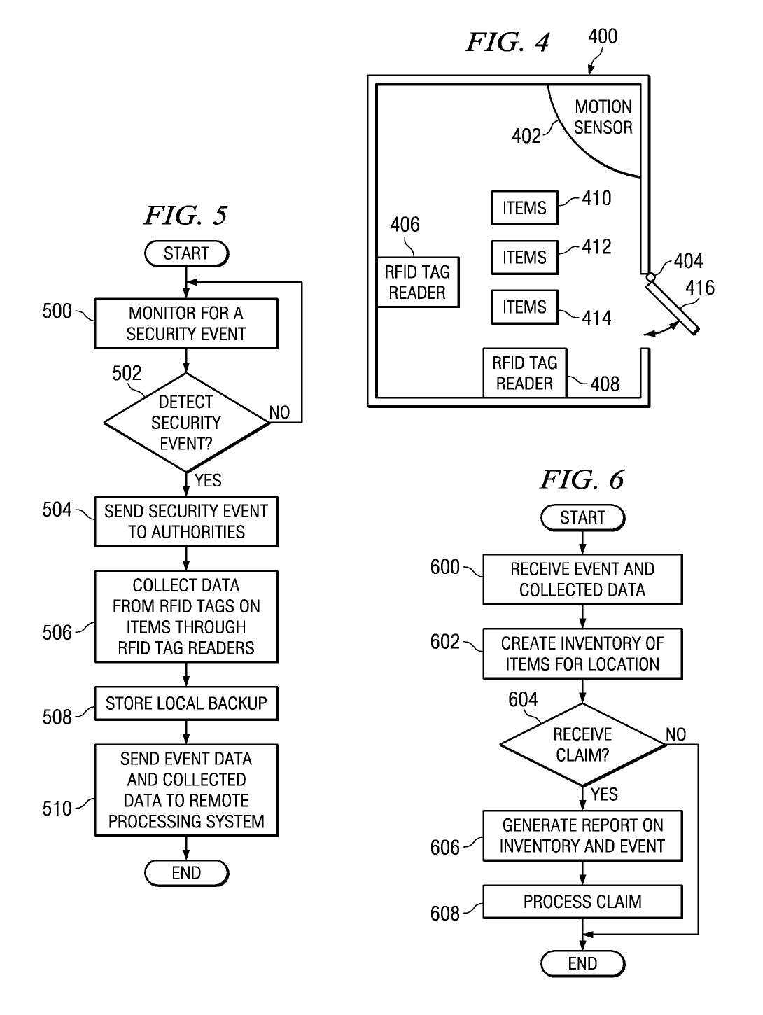

Turning now to FIG. 4, a diagram illustrating components used to detect security events and collect information on items is depicted in accordance with an illustrative embodiment. In this example, location 400 may take various forms. For example, location 400 may be a store, a warehouse, an office, or a home. Location 400 contains motion sensor 402 and door sensor 404. These sensors are examples of sensors 302 in FIG. 3. Two sensors are depicted only for purposes of illustrating one implementation for the different embodiments. Of course, other types and/or numbers of sensors may be used depending on the implementation.

Additionally, location 400 also contains RFID tag readers 406 and 408. These tag readers are examples are of RFID tag readers 306 in FIG. 3. Further, items 410, 412, and 414 are present within location 400. These items are tagged items in these examples. In other words, these items are items that are associated with RFID tags. In these examples, the RFID tags may be implemented using any RFID tags currently available. When one of the RFID tags is read by RFID tag reader 406 or 408, the information transmitted by the RFID tag may provide identification or location information about the item. Also, the specifics of the item tagged, such as price, color, date of purchase, and type of item may be transmitted.

When a signal is received, the energy is used to transmit the data back to RFID tag readers for passive RFID tags. In these examples, the RFID frequencies are 125 kHz and 135.5 kHz. The frequency used may vary depending on the implementation. Although the RFID tags may be active, in these examples, the tags are passive.

When a security event, such as movement within location 400 or the opening of door 416 occurs, this event is sent to a controller such as controller 304 in FIG. 3. In turn, the controller activates RFID readers 406 and 408 to collect information from RFID tags associated with items 410, 412, and 414. As a result, data identifying any of items 410, 412, and 414 is collected when the security event is detected.

This data is used to generate an inventory of items present at location 400. As a result, issues and problems associated with claiming that items were present at location 400, when the items were really not ever present is reduced through this type of system used to generate an inventory of items.

Turning now to FIG. 5, a flowchart of a process for generating an inventory in response to an event occurring at a location in accordance with an illustrative embodiment. This process may be implemented in a controller, such as controller 304 in FIG. 3.

The process begins by monitoring for a security event (step 500). The process determines whether a security event is detected (step 502). If a security event is detected in step 502, the process sends security event to the authorities (step 504). In these examples, the authorities are for example, a police department, a security company, or a fire department. The process then collects data from RFID tags on items through RFID tag readers (step 506).

The process then stores the data to a local backup (step 508). Finally, the process sends the event data and collected data to a remote processing system (step 510) and terminates. The remote data processing system is in these examples at insurance company. The system also may be located, for example, at another location for the owner or a security company.

Turning back to the determination made in step 502, if the process determines a security event is not detected, the process returns to step 500 and continues to monitor for a security event.

With respect to the data gathered in FIG. 5, the insured party has the responsibility to submit a claim in these examples. Nothing happens on the part of the insurance company until the claim is made.

Turning now to FIG. 6, a flowchart of a process for receiving and processing data collected during a security event in accordance with an illustrative embodiment. This process may be implemented in a monitoring system, such as monitoring system 308 in FIG. 3.

The process begins by receiving event and collected data (step 600). The process then creates an inventory of items for the location (step 602). The process determines if a claim has been received (step 604). If the claim was received in step 604, the process generates a report on the inventory and event (step 606) and the claim is processed (step 608). After the claim is processed, the process is terminated. The processing of the claim in step 608 follows processes normally used by insurance companies in these examples. This processing, however, has the benefit of the inventory of items present when the security event occurred.

Turning back to the determination made in step 604, if the process determines the claim was not received, the process terminates. At some point, the inventory may be discarded when a determination is made that no claim will be filed.

In this manner, the illustrative embodiments provide a computer implemented method, apparatus, and computer usable program code for handling security events. The different embodiments described gather data from radio frequency identifier tags present at a location when a security event is detected. This data is sent to a remote location for processing.

The illustrative embodiments provide an accurate and verifiable inventory of items present within a location, reducing the opportunity for fraud by a customer. In this manner, insurance carriers may be better protected from fraudulent claims reducing the cost of insurance. Further, the customer is protected from the loss of items by having a proof of inventory without having to use more traditional methods of photographs or having inventory lists that may be questioned.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for handling security events, the computer implemented method comprising:
responsive to detecting the occurrence of a security event at a location, gathering data from a plurality of radio frequency identifier tags present at the location through a set of radio frequency identifier tag readers located at the location to form tag data; and
sending the tag data to a remote location for processing.

2. The computer implemented method of claim 1 further comprising:
detecting the security event from a sensor at the location.

3. The computer implemented method of claim 2, wherein the sensor is selected from one of a fire detector, smoke detector, motion detector, glass break detector, or door sensor.

4. The computer implemented method of claim 1, wherein the security event is generated by a security system located at the location.

5. The computer implemented method of claim 1, wherein the plurality of radio frequency identifier tags are attached to items at the location.

6. The computer implemented method of claim of 1, wherein each radio frequency tag identifier transmits tag data identifying items located at the location to the set of radio frequency identifier tag readers once the radio frequency tag reader initializes the tags.

7. The computer implemented method of claim 1 further comprising:
responsive to receiving the security event and the tag data, generating an inventory of items present at the location.

8. An apparatus comprising:
a controller;
a set of sensors located in a location, wherein the set of detection devices are connected to the controller and wherein the set of detection devices send an event detected by the set of detection devices to the controller; and
a set of radio frequency identifier tag readers connected to the controller, wherein controller collects data from a plurality of radio frequency identifier tags associated with items present at the location through the set of radio frequency identifiers tag readers in response to receiving the event from the set of sensors and wherein the controller sends the event and the data collected from the a plurality of radio frequency identifier tags to a remote location for processing.

9. The apparatus of claim 8 further comprising:
a data processing system located at the remote location, wherein the data processing system processes the data to generate an inventory of items present at the location at a time when the event was generated.

10. A computer program product comprising:
a computer usable medium having computer usable program code for handling security events, the computer implemented method comprising:
computer usable program code, responsive to detecting the occurrence of a security event at a location, for gathering data from a plurality of radio frequency identifier tags present at the location through a set of radio frequency identifier tag readers located at the location to form tag data; and
computer usable program code for sending the tag data to a remote location for processing.

11. The computer program product of claim 10 further comprising:
computer usable program code for detecting the security event from a sensor at the location.

12. The computer program product of claim 11, wherein the sensor is selected from one of a fire detector, smoke detector, motion detector, glass break detector, or door sensor.

13. The computer program product of claim 10, wherein the security event is generated by a security system located at the location.

14. The computer program product of claim 10, wherein the plurality of radio frequency identifier tags are attached to items at the location.

15. The computer program product of claim of 10, wherein each radio frequency tag identifier transmits tag data identifying items located at the location to the set of radio frequency identifier tag readers once the radio frequency tag reader initializes the tags.

16. The computer program product of claim 10 further comprising:
computer usable program code, responsive to receiving the security event and the tag data, generating an inventory of items present at the location.

17. A data processing system comprising:
a bus;
a communications unit connected to the bus;
a storage device connected to the bus, wherein the storage device includes a set of computer usable program code; and
a processor unit connected to the bus, wherein the processor unit executes the computer usable program code to gather data from a plurality of radio frequency identifier tags present at a location through a set of radio frequency identifier tag readers located at the location to form tag data in response to detecting the occurrence of a security event at the location; and send the tag data to a remote location for processing.

18. The data processing system of claim 17 further executes the computer usable program code to detect the security event from a sensor at the location.

19. The data processing system of claim 18, wherein the sensor is selected from one of a fire detector, smoke detector, motion detector, glass break detector, or door sensor.

20. The data processing system of claim 17, wherein the security event is generated by a security system located at the location.
